(19) United States
(12) Patent Application Publication
(10) Pub. No.: US 2024/0270467 A1
(43) Pub. Date: Aug. 15, 2024

(54) STABLE BIODEGRADABLE RECEPTACLE

(71) Applicant: PAPACKS SALES GMBH, KOELN (DE)

(72) Inventor: Tahsin Dag, Koeln (DE)

(73) Assignee: PAPACKS SALES GMBH, KOELN (DE)

(21) Appl. No.: 18/568,025

(22) PCT Filed: Jun. 8, 2022
(86) PCT No.: PCT/EP2022/065571

§ 371 Date: Dec. 7, 2023

(30) Foreign Application Priority Data
Jun. 8, 2021 (DE) 102021114743.3

(51) Int. Cl. B65D 65/46; B65D 65/42; B65D 77/20; B65D 85/804; D21H 19/82; D21H 21/16; D21H 27/10; D21J 1/08; D21J 3/10

(52) U.S. Cl. CPC B65D 65/466; B65D 65/42; B65D 77/2024; B65D 85/8043; D21H 19/824; D21H 21/16; D21H 27/10; D21J 1/08; D21J 3/10

(57) ABSTRACT

The invention relates to a receptacle (1) with a container (2) of fiber material having at least one opening (7) and a base (3) and a cover (10) for the opening (7), wherein the container (2) has a biodegradable coating. The invention further relates to a method for manufacturing the receptacle (1).

The underlying problem of the invention is to provide a receptacle (1) which is formed exclusively from biodegradable components, which has a high gas-impermeability and a high mechanical stability and the manufacture of which is particularly flexible and cost-effective.

To solve the problem, the container (2) has a biodegradable, cured impregnation which at least locally reinforces the structure of the container (2).

The invention relates to a receptacle with a container made of fiber material having at least one opening and a base and a cover for the opening, wherein the container has a biodegradable coating. The invention further relates to a method of manufacturing the receptacle.

WO 2020/216719 A1 discloses a method for the production of coated substrates in which a flowable and biodegradable first coating increasing the gas impermeability is applied to a cellulose-containing substrate and this is solidified to form a coating. In order to achieve a packaging consisting primarily of natural raw materials with good gas and water impermeability, a second waterproof coating of animal and/or vegetable waxes and/or lipids is applied to the first coating.

WO 2006/059112 A2 discloses a method for producing a biodegradable composite material from plant material. The plant material can be in the form of a pulp and can be used to produce a container. By immersing such a composite container in hot wax, the container can be coated with biodegradable wax. WO 2006/059112 A2 also discloses that the coated substrate can be hot pressed.

GB 2567418 discloses a biodegradable and compostable coffee capsule made of fiber material, which is provided with a biodegradable plastic coating on the inner side and/or outer side. The coating can be thicker, particularly in the region of a flange/ring at the upper end of the capsule, where it can cause mechanical reinforcement.

A biodegradable portion pack (e.g. a coffee capsule) is also known from EP 2 218 653 A1, which is formed, for example, from a gas-impermeable material. The portion pack can be completely or partially surface-treated and/or coated. It can also have a local reinforcement consisting of a fiber layer. A sealing membrane is provided to seal the portion pack, which is connected to the portion pack in an airtight manner, in particular by heat sealing.

The receptacles known from the state of the art are either not made exclusively from biodegradable components or they have comparatively low mechanical stability.

The underlying problem of the invention is therefore to provide a receptacle which is formed exclusively from biodegradable components, which has a high gas-impermeability and a high mechanical stability and the manufacture of which is particularly flexible and cost-effective.

The problem is solved by a receptacle and a method with the features of the independent patent claims.

The receptacle comprises a container of fiber material having at least one opening and a base and a cover for the opening, the container having a biodegradable coating.

The fiber container is made from an aqueous pulp with cellulose fibers. The cellulose fibers are brought into a form by a simple sieving process using a suction form. The water is sucked out through pores in the suction mold and the cellulose fibers are deposited on the surface of the suction mold with the pores. In the transfer process, the molded product formed by the suction mold is transferred to a transfer mold so that it is shaped from both sides. Additional thermal processing and pressing processes can be used to improve the surface quality of the molded product. The molded products of fiber material formed in this way are firm and dimensionally stable.

The container made of fiber material produced in this way has an opening, a base opposite the opening and a peripheral wall surrounding the opening and the base. The opening and the base can be round, oval or polygonal, for example. A cover is attached or can be attached to the opening of the container, by means of which the opening of the container is closed or can be closed. The cover interacts with the container in such a way that the interior of the container is closed or can be closed off from the environment. The cover is also biodegradable.

Fiber material without a coating has a certain gas and water permeability. The fiber container described here has a biodegradable coating which increases its gas and water impermeability, especially when the cover interacts with the container. The coating can also increase the strength of the container. The coating of fiber material is generally known from the prior art. Coatings can be sprayed on, for example. Alternatively or additionally, a coating can be applied by immersing a fiber material in a coating bath and then drying it. For example, the applicant's publication WO 2020/216719 A1 discloses a biodegradable barrier coating for a cellulose substrate, which is well suited for coating the fiber containers described here.

To solve the above problem, the container has a biodegradable, cured impregnation which at least locally reinforces the structure of the container.

In other words, a biodegradable agent is proposed which interacts with the fiber material of the container in such a way that it structurally reinforces the container at least locally and gives it greater strength when cured. In addition, the impregnation may be resistant to moisture.

In general, the term impregnation refers to the soaking of a porous material with an agent. The selected agent therefore penetrates the pores and increases the strength of the porous material by curing. The selected impregnation can be a moisture-repellent agent, also known as a hydrophobic agent.

When such agents are wetted with a drop of water, the so-called wetting angle between the surface of the hydrophobic agent and the drop of water is large. In particular, no moisture can penetrate the impregnation.

Fiber products made of fiber materials, such as the fiber container described here, regularly contain pores into which moisture, water or other liquids can penetrate. Such porous fiber containers, which are usually made of cellulosecontaining fiber material, usually have limited strength, especially when they are soaked. In order to increase the resistance, the pores can be sealed with the curing impregnation, at least in selected regions. For example, the impregnation can penetrate into the pores of the fiber container and fill them. Since the impregnation, as mentioned above, preferably does not absorb any moisture itself, the impregnated fiber material not only becomes stronger but also absorbs little or no moisture with the filled pores.

With the container described here, complete impregnation of the fiber material is not absolutely necessary. It is sufficient if at least the pores of a locally limited region are filled with the impregnation and/or if at least the pores near the surface of the fiber material are sealed by the impregnation. To seal the pores, the pores do not have to be completely filled with the impregnation. It is sufficient if they are at least partially filled and/or partially sealed.

The impregnation described here can have at least two aggregate states. During application it is liquid and in its intended state as an impregnation it is cured. In particular, it can be thermoplastic for this purpose. This means that the impregnation is flowable in a heated state and solidifies when it cools down. Such a change in the aggregate state of thermoplastic materials is reversible. Alternatively, it is also possible that the impregnation is only flowable during impregnation and cures irreversibly in its intended state as an impregnation in the manner of duromers or elastomers.

When cured, the impregnation has a higher strength than the fiber material from which the container is formed. The strength of the impregnation may also be higher than the strength of the sealing coating of the fiber material. After impregnation, the container can therefore withstand higher mechanical stresses than the container with a coating without impregnation. As the impregnation is biodegradable, the entire receptacle is made exclusively from biodegradable materials. Biodegradable means that the materials can decompose under certain anaerobic or aerobic conditions.

In practice, the impregnation can be compostable. Compostable means that the impregnation is formed from organic material that is decomposed by soil organisms under the influence of atmospheric oxygen, i.e. under aerobic conditions. Preferably, not only the impregnation is compostable, but all components of the receptacle are compostable. In practice, the receptacle and in particular the impregnation can be compostable without industrially defined conditions. This means that composting is also possible without an industrial composting plant. Even if the receptacle is not disposed of with the sorted compost waste but is released into the environment, it can decompose within a few months. In contrast, the vast majority of compostable, mechanically reinforced receptacles are usually only compostable under industrially defined conditions or over long periods of several years. The ecological footprint of the receptacle described here is therefore considerably minimized compared to receptacles made of many other materials with similar mechanical stability.

In practice, the impregnation can be applied in the region of the opening and/or in the region of the base. These regions are often exposed to particularly high mechanical stresses, so that the mechanical reinforcement of the container material in these regions is particularly useful.

In practice, the impregnation can be applied to a surface facing the interior of the container (the inner side). Additionally or alternatively, the impregnation may be applied to the outward-facing surface (the outer side) of the container or completely saturate the container wall. As mentioned above, it may be sufficient to apply the impregnation only locally.

The impregnation can form a primer for the coating of the container. If the impregnation is only applied on one side of the container (i.e. either on the inner side or on the outer side), the coating may alternatively or additionally be applied on the side of the container on which the impregnation is not applied. If the container is provided locally with the impregnation, the coating can be applied partly on the impregnation and partly directly on the fiber material.

In practice, the coating may contain at least one of the following components:
cellulose fibers,
casein,
whey,
agar agar,
psyllium husks.

As mentioned above, the coating increases the gas-impermeability of the container and can also increase its strength.

Cellulose nanofibrils or microfibrils can, for example, be dissolved in water and sprayed onto the container. Nanocellulose has cellulose microfibrils with a median diameter in the range from 30 to 100 nm and/or cellulose nanofibrils with a median diameter in the range from 5 to 20 nm. Industrially marketed cellulose fibrils are often a mixture of microfibrils and nanofibrils. In practice, a mixture of 2% by weight of nanocellulose in 98% by weight of water has proven to be effective for the primer. If a higher proportion of cellulose is selected, deformation of the container due to moisture can be reduced or avoided and the drying time of the primer can be shortened. In practice, a cellulose content of the primer solution of 2 to 10% by weight is suitable.

There are other organic materials that can be used in a coating to increase the impermeability of a container against gas penetration. For example, casein powder can be mixed with water and denatured using calcium hydroxide. The casein increases the impermeability and mechanical strength of the container. Casein denatured with calcium hydroxide also becomes water-repellent to a certain extent. It is also possible to denature the casein with sodium bicarbonate, but this does not make it water-repellent.

In practice, 30 g casein powder was left to swell with 100 ml water for around 8 to 10 hours, 30 g calcium hydroxide was added and stirred. After adding another 50 ml of water, the solution was sieved and used for coating. This coating can be applied after the coating with cellulose fibers or as an alternative to the coating with cellulose fibers. The coating can also contain both cellulose fibers and casein.

Whey is also suitable as a component of the coating. Whey can be denatured by heat (90°−100° C.). Whey as a component of the coating also increases the strength of the coated container. The whey coating itself is not water-repellent, but can be made waterproof with a second coating.

Finally, gel-forming ingredients such as agar agar (gelatine from algae) or psyllium husks (seed husks of the plantain species Plantago indica, Plantago afra) are suitable for adding to the coating. Agar agar powder, for example, is mixed with water for this purpose and denatured at 100° C. for 1 minute. When it cools, it solidifies and gels. The gel can be applied to the container and forms a thin layer that seals the pores of the fiber material that are not yet sealed, increases strength and repels water.

A similar effect is achieved when ground psyllium husks are soaked in water and applied to the container after approx. 20 minutes of swelling.

As mentioned, the components of the coating can be simultaneously dissolved in water and applied as a mixture. However, it is also possible to apply the coating to the container as several layers with different components. All the possible components of the primer mentioned above are biodegradable.

In practice, the impregnation can be constituted by carnauba wax. Carnauba wax is a very hard, tropical wax with a high melting temperature (approx. 85-89ºC). It has hardly any odor or taste of its own and is waterproof. It is very brittle when dry and solidifies within seconds. Due to its hardness, it is also very resistant to abrasion. It is approved for food packaging and has long been used as a coating to increase the shelf life of mangoes, sweets, etc. Additionally, the impregnation may contain beeswax or other natural waxes. Combinations of biodegradable and preferably also compostable waxes can be used for the impregnation, which give the molded fiber product the desired strength and are particularly suitable for use with the packaged food. In addition to carnauba wax and beeswax, shellac and sugar cane wax, for example, are also suitable for use in the agent for impregnating the molded fiber body of the container.

Beeswax is a wax produced in Europe, among other places, which is less hard than carnauba wax. In a mixture with carnauba wax, beeswax helps to reduce brittleness. It also has hardly any odor or taste of its own and is approved for use in combination with food. Its melting point is approx. 65° C.

In practice, the container may further comprise a flange and this flange may be provided with the impregnation. The flange is formed integrally with the container of coated fiber material. In particular, the flange may project radially outwards at the upper end of the peripheral wall in the region of the opening. This provides a large surface to which the cover can be attached. This design of the receptacle is particularly well suited as, for example, beverage powder portion packaging, especially as a coffee capsule. By impregnating the flange, the flange and the region of the container adjacent to it are mechanically reinforced. Such reinforcement is particularly advantageous for coffee capsules with a container made of fiber material, since a gripping mechanism of coffee machines for coffee capsules engages the flange in order to move the coffee capsule from a first position to a second position. The impregnation of the flange provides the fibrous coffee capsules with the necessary strength and resistance to moisture.

A coffee portion packaging in the form of a capsule consisting of the receptacle described here has a high degree of impermeability, which is much higher than that of conventional coffee pods made of uncoated cellulose fibers, and a better environmental compatibility than conventional coffee capsules made of aluminum. As a result, coffee can be stored for a long time without producing a lot of waste. The coffee capsule described here consists solely of natural raw materials and can be easily biodegraded and/or composted.

However, the receptacle described here can also be used for other purposes. It can be used as a transport container, in particular a disposable transport container for any foodstuffs in solid or liquid form as well as for bulk goods. The container can have the shape of a bottle. The impregnation can structurally reinforce the upper section, which has the contour of an external thread. A screw cap can be screwed onto this external thread. Furthermore, the bottle base can be structurally reinforced by the impregnation. The receptacle can be a yoghurt pot sealed with sealing film. The receptacle can also be used as packaging for products other than food, especially if these products are to be protected against drying out or against gas exchange with the environment.

In practice, the cover of the receptacle can be designed as a sealing film. Sealing films can consist of densely coated fiber material. They are thin, flexible and at the same time gas-tight. In particular, the coating of the sealing film can be identical to the coating of the container. However, it can also have a different composition. If the coating of the cover is identical to the coating of the container and/or these two coatings can be dissolved using the same solvent, the container and the cover can be joined together particularly easily and securely by means of material bonding. For example, the coated and not yet completely dry cover can be placed on the opening of the container in such a way that the opening is completely covered. The container and the cover can then be pressed together, whereby the coating of the container is dissolved and later dries in conjunction with the coating of the cover. By covering and joining in this way, the receptacle has minimal material consumption and only a few different materials, which is advantageous for biodegradability and/or compostability.

The invention also relates to a method for producing a receptacle comprising a container made of fiber material having at least one opening and a base, a cover for the opening; a biodegradable coating; and a biodegradable cured impregnation at least locally reinforcing the container. The method comprises the steps of:
suction of fiber material from a pulp using a suction mold and compacting the fiber material into the container;
dewatering and drying the container;
impregnating at least a part of the container with the impregnation;
curing of the impregnation;
coating the container with the coating;
attaching the cover.

The container is conventionally produced by first forming a pulp with fiber material. The fiber material can be sieved from the pulp and/or sucked by means of a suction mold and compacted, for example by pressing with a counter mold, to form a molded product made of fiber material. In a subsequent step, the molded product can be dewatered, for example by pressing again, and dried, for example by heating in an oven, before the resulting fiber container is at least locally impregnated with a liquid impregnation. For example, only the base and/or only the region with the opening is impregnated. The impregnation may then cure so that it becomes solid and increases the strength and possibly the moisture resistance of the impregnated regions of the fiber container. Curing can take place in an oven at an elevated temperature, for example.

In a further step, the impregnated container can be coated, which increases its impermeability against the passage of gases or liquids. The sealing coating is applied in particular to the inner side of the container in order to safely and tightly contain the foodstuffs inside.

After filling, the cover can be attached to the molded fiber container so that the opening of the container is closed and a closed, gas-tight, at least locally reinforced and locally water-repellent receptacle is formed.

With regard to further details of the respective method steps, reference is also made to the above description of the features thus generated. The advantages mentioned in connection with these features apply to the method accordingly.

As mentioned above, the container can be hot-pressed at least after the impregnation has been applied, allowing the impregnation to penetrate the fiber material better. This also allows a particularly high geometric precision of the container and flat surfaces to be achieved. In addition or alternatively, hot pressing can be carried out after dewatering and drying the fiber material product. In this case, residual moisture can also be removed from the fiber material. Finally, the container can be hot-pressed after coating and before filling.

In practice, the impregnation can be applied by immersing the container in a hot bath. Immersion in a hot bath is a particularly simple, quick and cost-effective way of applying the impregnation. In addition, the coating can be applied locally and in particular in the region of the base and/or in the region of the opening of the container (possibly with the flange, if this is provided). The applied impregnation can then cure.

The impregnation can also be sprayed on and then hot-pressed if necessary. Finally, it is possible to introduce the wax into the regions of a hot press mold in which the impregnation is to be produced. In this case, the hot press mold is heated to a temperature above the melting temperature of the impregnation.

In practice, the coating can be applied to the container by spraying. Spraying the coating described above is a particularly simple, quick and cost-effective way of applying the coating to the fiber material product. Furthermore, spraying allows the formation of a particularly homogeneous and/or thin coating.

Further practical embodiments and advantages of the invention are described below in connection with the drawings.

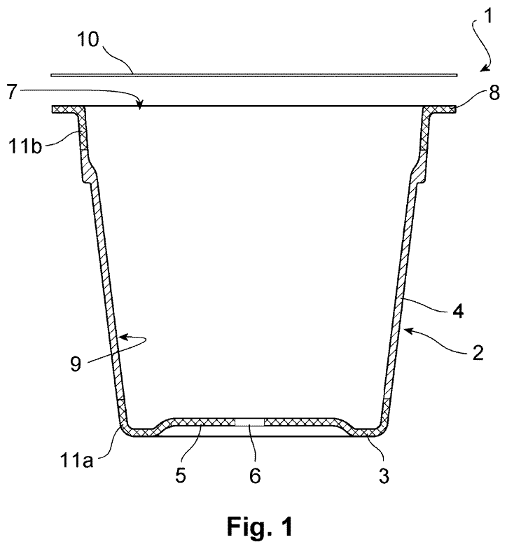

FIG. 1 shows the receptacle according to the invention in an embodiment as a coffee capsule in a vertical sectional view;

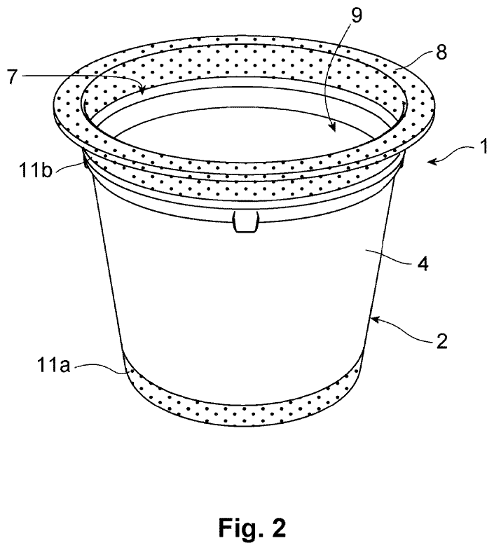

FIG. 2 shows the receptacle according to the invention of FIG. 1 without a cover in an oblique view from above;

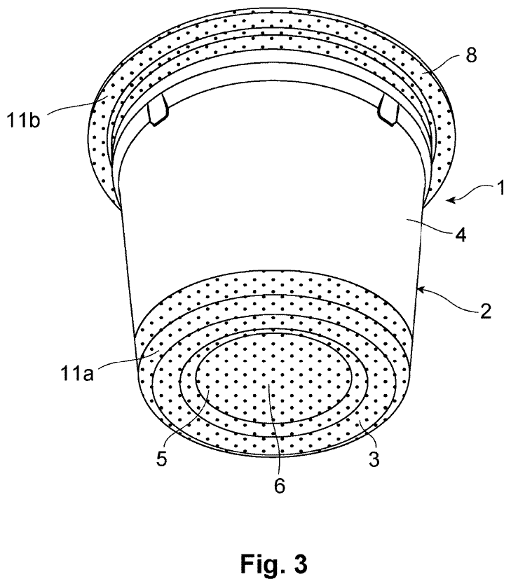

FIG. 3 shows the receptacle according to the invention of FIG. 1 in an oblique view from below;

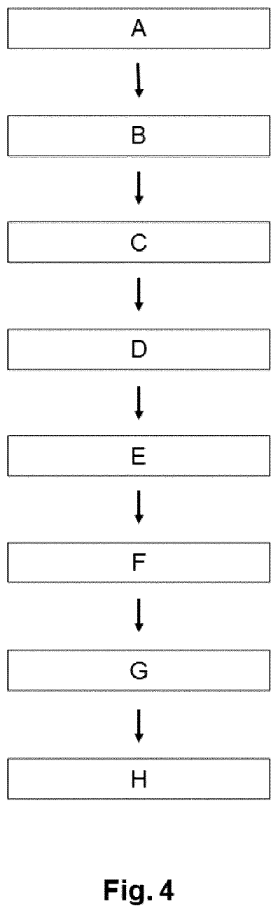

FIG. 4 shows a manufacturing method for producing the receptacle according to the invention.

FIGS. 1 to 3 show a receptacle 1 that is designed as a coffee capsule. The receptacle 1 has a container 2 and is essentially rotationally symmetrical. It has a base 3 and a peripheral wall 4 surrounding the base 3. A central and rotationally symmetrical recess 5 with a perforation region 6, which is also rotationally symmetrical and centrally arranged therein, is formed in the base 3. The perforation region is to be pierced by at least one needle in order to allow liquid fed into the receptacle 1 under pressure to escape. The recess 5 is oriented towards the inside of the container, i.e. towards an opening 7 of the container 2 opposite the base 3. At the opening 7, the container 2 has a flange 8 that rotationally symmetrically surrounds the opening 7 and the peripheral wall 4. The flange 8 points outwards from the peripheral wall 4 in a radial direction and is oriented essentially parallel to the base 3.

The container 2 with the base 3, the peripheral wall 4 and the flange 8 is formed in one piece from fiber material. A coating (not shown) is applied to the inner side 9 of the container 2 facing into the container interior and to the upward-facing surface of the flange 8. The coating can be made of cellulose and casein, for example, and is therefore biodegradable. However, it may additionally or alternatively also contain other biodegradable components, for example whey, agar agar and/or psyllium husks. The coating increases the gas-impermeability and mechanical stability of the container 2.

The opening 7 can be covered with the cover 10, which is shown at a distance above the container 2 in FIG. 1 for a better overview and is designed as a sealing film. The sealing film 10 is flexible and at the same time gas-tight. As intended, it is fixed in place on the flange 8 and thus seals the interior of the container from the environment. For fixing on the flange, the sealing film 10 has the same coating (not shown) on the surface oriented in the direction of the flange 8 as the inner side 9 of the container and the upward-facing surface of the flange 8. The coatings of the sealing film 10 and the flange 8 are bonded to each other.

Both, in the region of the base 3 and in the region of the opening 7, the receptacle 1 has an impregnated region 11a, 11b. In the sectional view in FIG. 1, the impregnated regions 11a, 11b are highlighted by cross-hatching. In FIGS. 2 and 3, the surfaces of the impregnated regions 11a, 11b are highlighted with dots. In both regions 11a and 11b, the impregnation consists of the same strengthenhancing material, which solidifies on cooling. This material can be, for example, carnauba wax or a mixture of carnauba wax and beeswax. The impregnated regions 11a, 11b completely penetrate the fiber material from which the container 2 is formed. In this respect, all or almost all of the pores of the fiber material in the regions of the base 3 and the opening 7 described here are completely or almost completely filled with the impregnation over the entire wall thickness of the container. Immersion not only fills the pores of the fiber material, but also covers at least the fibers on the outer side of the container with the impregnation. The impregnation thus also forms a primer for a coating applied on top.

FIG. 4 shows a possible manufacturing method for the production of the receptcale according to the invention with the method steps A to H.

According to this manufacturing method, a pulp with fiber material is formed in a first method step A. The fiber material is sucked out of the pulp using a suction mold and then compacted by pressing with a transfer mold to form the container 2 made of fiber material. In a further method step B, the container 2 is transferred from the transfer mold to a counter mold, in which the container 2 is dewatered by renewed, stronger pressing. It is then transferred to an oven chamber where it is dried at an elevated temperature of 180° C., for example. In a further method step C, the dried fiber container is hot-pressed in order to increase its dimensional stability and remove any remaining moisture. In a further method step D, wax is applied locally to the container 2 to form the impregnated regions 11a, 11b. The wax can be applied by first immersing the container 2 with the base 3 to a predefined immersion depth in a hot bath of the wax. The container 2 is then turned over and the region of the opening 7 is immersed in the same hot bath. Of course, a different hot bath, possibly with a different impregnation, can also be used for the second region of the impregnation. Subsequently (method step E), the impregnated container 2 is hotpressed again in order to further improve its dimensional stability and to be able to better introduce the impregnation into the pores of the fiber material.

As an alternative to applying the impregnation in a hot bath, the mold for hot pressing can also be filled with the agent to be applied. Method step D can then be omitted.

After hot pressing, the container 2 is transferred to another oven in method step F. In this further oven, the wax can penetrate deeper into the pores of the fiber material. This treatment can take place at 90° C., for example.

In a subsequent method step G, the coating is applied to the inner side 9 of the fiber container 2 and the upward-facing side of the flange 8 by spraying. In a final method step H, the sealing film 10 is coated with the same aqueous coating as the inner side of the fiber container and the upper side of the flange and the sealing film 10 is glued to the upward-facing side of the flange 8 with the coating still wet, so that a cover is formed which closes the opening of the container in a gas-tight manner.

As a result, the receptacle 1 described here has a biodegradable, cured impregnation that penetrates the container wall in the region of the base 3 and the opening 7 of the container 2. In addition, the receptacle 1 has a biodegradable and gas-tight coating covering the entire inner side 9 of the container 2 and the side of the cover 10 facing the inner side of the container. In the region of the opening 7 of the container 2, the coating is applied to the impregnation that was applied first. In this region, there is therefore a multi-layer system on the inner side 9 of the container 2, consisting of the impregnation located directly on the inner side 9 and the coating formed thereon.

The features of the invention disclosed in the present description, in the drawings and in the claims may be essential, both individually and in any combination, for the realization of the invention in its various embodiments. The invention is not limited to the described embodiments. It may be varied within the scope of the claims and taking into account the knowledge of the person skilled in the art.

### LIST OF REFERENCE SIGNS

1 receptacle, coffee capsule
2 container
3 base
4 peripheral wall
5 recess
6 perforation region
7 opening of the container
8 flange
9 inner side
10 cover, sealing foil
11a impregnated region
11b impregnated region
A method step (suction of fiber material from a pulp using a suction mold and compaction of the fiber material into the container)
B method step (dewatering and drying the container)
C method step (hot pressing of the container)
D method step (immersion of a part of the container in a hot bath of an impregnating agent)
E method step (hot pressing of the impregnated container)
F method step (curing of the impregnation)
G method step (coating the container with the coating by spraying)
H method step (attaching the cover)

1. (canceled)

2. (canceled)

3. (canceled)

4. (canceled)

5. (canceled)

6. (canceled)

7. (canceled)

8. (canceled)

9. (canceled)

10. (canceled)

11. A biodegradable container, comprising:
a peripheral wall;
at least one opening region comprising at least one opening, at least one flange, and an upper portion of the peripheral wall of the container;
at least one bottom region comprising at least one base and at least one lower portion of the peripheral wall of the container;
wherein the container is molded from an aqueous pulp containing cellulosic fibers;
wherein the container is porous;
wherein the at least one flange protrudes radially outward from the at least one opening of the container;
wherein a plurality of pores in the at least one opening region is configured to receive at least one impregnation agent applied to the at least one opening region;
wherein the at least one impregnation agent is configured to penetrate the plurality of pores;
wherein the at least one impregnation agent is configured to harden irreversibly into a hardened state after application; and
wherein the at least one impregnation agent in the hardened state has a higher strength than the cellulosic fibers of the container.

12. The container of claim 11, wherein the at least one impregnation agent is exclusively applied to the at least one opening region and/or the at least one bottom region of the container.

13. The container of claim 11, wherein the container comprising the at least one impregnation agent is configured to absorb and withstand a greater amount of mechanical stress than a container without the at least one impregnation agent.

14. The container of claim 11, wherein the container further comprises a primer layer applied to the container and a water-resistant coating layer applied to the primer layer, such that the container comprises the at least one hardened impregnation agent, a primer layer, and a water-resistant coating layer.

15. The container of claim 11, wherein the container and the at least one impregnation agent consist exclusively of biodegradable materials.

16. The container of claim 11, wherein the at least one impregnation agent includes carnauba wax, beeswax, shellac, and/or sugar cane wax.

17. The container of claim 11, wherein the at least one opening is sealed by at least one cover, wherein the at least one cover is affixed to the at least one flange such that the at least one cover provides a gas impermeable barrier across the at least one opening of the container.

18. The container of claim 11, wherein the plurality of pores in the at least one opening region are at least partially filled by the at least one impregnation agent.

19. The container of claim 11, wherein the at least one impregnation agent is applied via spray coating or partial or full immersion of the container.

20. A method of mechanically reinforcing a biodegradable container, comprising:
molding a three-dimensional container, wherein molding the three-dimensional container includes:
applying an aqueous pulp solution to a mold, wherein the mold is in the shape of the container;
negatively pressurizing the aqueous pulp solution, wherein a fibrous material suspended within the aqueous pulp solution is compacted into a fibrous matrix in the shape of the mold to form the container, and wherein the fibrous matrix of the container comprises a plurality of pores; and
dewatering and drying the container;
immersing at least a portion of the container into a bath comprising at least one impregnation agent, wherein the at least one impregnation agent penetrates the plurality of pores in the fibrous matrix of the container;
hardening the at least one impregnation agent;
coating the container with a coating, wherein the coating increases the gas impermeability of the container; and
applying a cover to at least one flange of the container, wherein the at least one flange extends radially outwards from at least one opening of the container, wherein the cover forms a gas impermeable seal over the at least one opening of the container.

21. The method of claim 20, wherein the at least one impregnation agent is exclusively applied to at least one top portion of the container and/or at least one bottom portion of the container.

22. The method of claim 20, wherein the coating comprises cellulose fibers, casein, whey, agar-agar, and/or psyllium husks.

23. The method of claim 20, wherein the at least one impregnation agent includes carnauba wax, beeswax, shellac, and/or sugar cane wax.

24. The method of claim 20, wherein the cover is a sealing film, wherein the sealing film comprises a fibrous sealing material.

25. The method of claim 20, further comprising coating the cover with the coating before applying the cover, such that the container and the cover are coated in the same coating, and further comprising pressing the cover together with the at least one flange, wherein the coating of the cover and the coating of the container are materially connected.

26. A biodegradable container, comprising:
a peripheral wall;
at least one opening region comprising at least one opening, at least one flange, and an upper portion of the peripheral wall of the container;
at least one bottom region comprising at least one base and at least one lower portion of the peripheral wall of the container;
at least one cover;
a biodegradable cover coating; and
a biodegradable container coating;
wherein the container is molded from an aqueous pulp containing cellulosic fibers;
wherein the container is porous and comprises a plurality of pores;
wherein the at least one flange protrudes radially outward from the at least one opening of the container;
wherein a plurality of pores in the at least one opening region and the at least one bottom region is configured to receive at least one impregnation agent applied to the at least one opening region and the at least one bottom region;
wherein the at least one impregnation agent is configured to penetrate the plurality of pores;
wherein the at least one impregnation agent hardens irreversibly into a hardened state after application;
wherein the at least one impregnation agent in the hardened state has a higher strength than the cellulosic fibers of the container;
wherein the container is coated with the biodegradable container coating;
wherein the at least one cover is coated with the biodegradable cover coating; and
wherein the biodegradable cover coating is configured to be dried together with the biodegradable container coating such that the at least one cover is in material connection with the at least one flange.

27. The container of claim 26, wherein the container, the at least one cover, and the at least one impregnation agent consist exclusively of biodegradable materials.

28. The container of claim 26, wherein the at least one impregnation agent includes carnauba wax, beeswax, shellac, and/or sugar cane wax.

29. The container of claim 26, wherein the biodegradable container coating and the biodegradable cover coating each comprise cellulose fibers, casein, whey, agar-agar, and/or psyllium husks.

30. The container of claim 26, wherein the at least one impregnation agent is a hydrophobic compound, wherein a wetting angle between the at least one impregnation agent and a drop of water applied to the at least one impregnation agent is greater than 90 degrees.
